(19) United States
(12) Patent Application Publication
(10) Pub. No.: US 2018/0069471 A1
(43) Pub. Date: Mar. 8, 2018

(54) OPTIMIZING THE EFFICIENCY OF A BOOST PRE-CONVERTER WHILE MAINTAINING INPUT POWER FACTOR

(71) Applicant: TEXAS INSTRUMENTS INCORPORATED, Dallas, TX (US)

(72) Inventors: Joseph Michael LEISTEN, Cork (IE); Ananthakrishnan VISWANATHAN, Allen, TX (US); Brent McDONALD, Murphy, TX (US); Philomena Cleopha BRADY, Corinth, TX (US)

(21) Appl. No.: 15/257,534

(22) Filed: Sep. 6, 2016

(51) Int. Cl. H02M 1/42; H02M 3/156

(52) U.S. Cl. CPC H02M 1/42; H02M 3/156

(57) ABSTRACT

A power factor correction (PFC) pre-converter includes a boost converter and a PFC controller. The boost converter is configured to step up a boost converter input voltage by generating a boost converter output voltage. The boost converter includes an inductor, a switch, and a diode. The PFC controller is configured to control the switch by generating a signal causing the switch to be closed for a first period of time. The first period of time ends when current through the inductor reaches a target current value. The PFC controller is also configured to control the switch by, in response to the first period of time ending, generating a signal causing the switch to be open for a second period of time. The second period of time is based on a ratio between the first period of time and a critical conduction mode on time.

### BACKGROUND

Power factor correction (PFC) pre-converters may be utilized in many applications, including as components in a switch mode power supply. In a switch mode power supply, a rectifier is configured to receive and rectify an alternating current (AC) line voltage into a DC signal. The PFC pre-converters are configured to receive the rectified line voltage and generate a DC voltage while also providing power factor correction. In other words, the PFC pre-converter is configured to draw a current that is proportional to and in phase with the AC sine-wave from the line voltage.

Conventional PFC pre-converters may operate in a critical conduction mode (CrCM). In the CrCM, a relatively simple control circuit is utilized to control switching in a boost converter. The PFC controller is configured to generate a fixed on time of the boost converter switch across the line cycle to automatically provide input current proportional to the input voltage, thus, providing power factor correction. Current flowing in the diode of the boost converter automatically discharges to zero at the end of each conduction period so that a relatively slow and cheap diode may be utilized.

### SUMMARY

The problems noted above are solved in large part by systems and methods of optimizing load efficiency of a power factor correction (PFC) pre-converter. In some embodiments, a power factor correction (PFC) controller includes a comparator, a first multiplier, a pulse extender, a divider, an adder, a second multiplier, and a gate pulse generator. The comparator is configured to compare an input current with a target current value and output a comparator output signal based on the comparison. The first multiplier is configured to generate a critical conduction mode on time based on a ratio of power demand for a boost converter in a PFC pre-converter to a peak line voltage. The pulse extender is configured to compare the comparator output signal to the critical conduction mode on time and output an adjusted on time based on the comparison. The divider is configured to divide the adjusted on time by the critical conduction mode on time to generate a discontinuous mode ratio. The adder is configured to add the adjusted on time to a discharge time to generate a power stage time. The second multiplier is configured to multiply the discontinuous mode ratio with the power stage time to generate a total period of time. The gate pulse generator is configured to, in response to the total period of time ending, generate a gate drive signal to close a switch in the boost converter.

Another illustrative embodiment is a power factor correction (PFC) pre-converter that includes a boost converter and a PFC controller. The boost converter is configured to step up a boost converter input voltage by generating a boost converter output voltage. The boost converter includes an inductor, a switch, and a diode. The PFC controller is configured to control the switch by generating a signal causing the switch to be closed for a first period of time. The first period of time ends when current through the inductor reaches a target current value. The PFC controller is also configured to control the switch by, in response to the first period of time ending, generating a signal causing the switch to be open for a second period of time. The second period of time is based on a ratio between the first period of time and a critical conduction mode on time.

Yet another illustrative embodiment is a method of optimizing load efficiency of a power factor correction (PFC) pre-converter. The method includes closing a switch in a boost converter of the PFC pre-converter a first time causing current to increase through an inductor of the boost converter from zero for a predetermined critical conduction mode on time. The method also includes monitoring current through the inductor. The method also includes, in response to current through the inductor being at a target current value at an end of the critical conduction mode on time, opening the switch causing current through the inductor to decrease to zero. The method also includes, in response to current through the inductor being less than the target current value at the end of the critical conduction mode on time, keeping the switch closed past the end of the critical conduction mode on time for an adjusted on time which ends when the current through the inductor is at the target current value. The method also includes, in response to the current through the inductor being at the target current value at the end of the adjusted on time, opening the switch causing current through the inductor to decrease to zero. The method also includes closing the switch a second time at an end of a total period of time, the total period of time being based on a ratio between the adjusted on time and the critical conduction mode on time.

### BRIEF DESCRIPTION OF THE DRAWINGS

For a detailed description of various examples, reference will now be made to the accompanying drawings in which:

FIG. 1 shows an illustrative block diagram of a power supply system in accordance with various embodiments;

FIG. 2 shows an illustrative circuit diagram of a power factor correction (PFC) pre-converter in accordance with various embodiments;

FIG. 3 shows an illustrative circuit diagram of a PFC controller in accordance with various embodiments;

FIG. 4 shows an illustrative timing diagram of current through an inductor of a boost converter of a PFC pre-converter in accordance with various embodiments; and

FIG. 5 shows an illustrative flow diagram of a method of optimizing load efficiency of a PFC pre-converter in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections. The recitation “based on” is intended to mean “based at least in part on.” Therefore, if X is based on Y, X may be based on Y and any number of other factors.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Power factor correction (PFC) pre-converters may be utilized in many applications, including as components in a switch mode power supply. Conventional PFC pre-converters may operate in a critical conduction mode (CrCM). In the CrCM, a control circuit is utilized to control switching in a boost converter. The PFC controller is configured to generate a fixed on time of the boost converter switch across the line cycle to automatically provide input current proportional to the input voltage, thus, providing power factor correction. Thus, peak current in the switching cycle is proportional to the input voltage because, as the input voltage changes, the slope of the increase in the current through the inductor of the boost converter changes at the same rate. Because the peak current through the boost converter is proportional to the input voltage, the average current is also proportional to the input line voltage. Hence the output voltage is power factor corrected. However, when the delivered power is lowered (i.e., the drawn current from the line voltage changes), the on time of the boost converter is also lowered, thus, reducing the peak current. Reducing the peak current reduces the average current. However, because the conventional PFC pre-converter is operating in CrCM, the switching frequency increases as input voltage decreases. In some cases, the switching frequency may increase many orders of magnitudes. Furthermore, every time a switching cycle commences, some amount of energy is lost, thus, when operating under a light load, the conventional PFC pre-converter is inefficient.

In accordance with the disclosed principles, a PFC pre-converter includes a PFC controller and a boost converter. The PFC controller acts to control the switching of the switch in the boost converter. In an embodiment, the PFC controller causes the switch to close which causes the current through an inductor in the boost converter to increase. The switch remains closed until the current through the inductor reaches a target current value that is set to optimize the efficiencies of the boost converter. Thus, in some embodiments, the on time of the boost converter is longer than in a conventional CrCM pre-converter. Once the current through the inductor reaches the target current value, the PFC controller causes the switch to open causing the current through the inductor to discharge. In order to also provide power factor correction, the PFC controller determines a total period between closing the switch. The total period is determined based on the ratio of the amount of time the switch is closed and the fixed amount of time the switch would be closed if operating in CrCM. That ratio then may be multiplied by the time that current is flowing through the inductor. In this way, the PFC pre-converter provides power factor correction while providing better efficiency than a conventional PFC pre-converter.

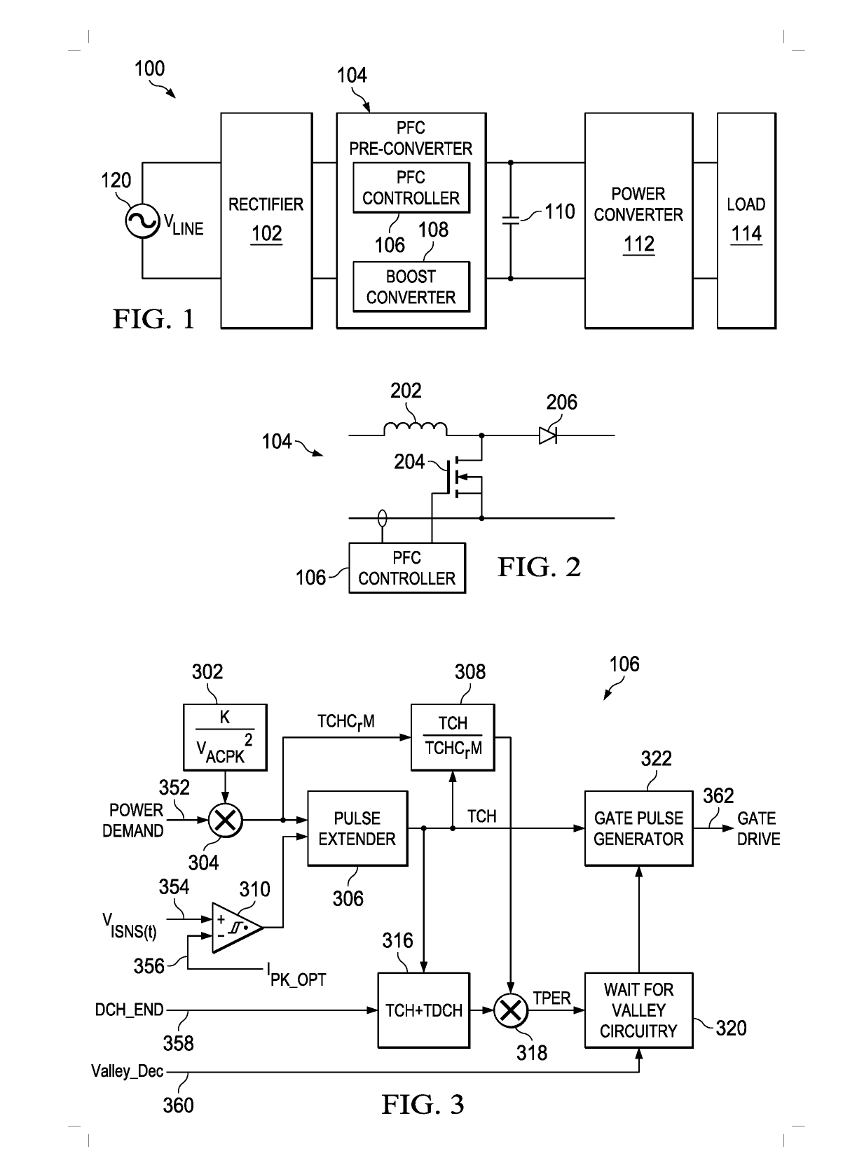

FIG. 1 shows an illustrative block diagram of a power supply system 100 in accordance with various embodiments. In some embodiments, power supply system 100 is a switch-mode power supply that may be configured to receive an alternating current (AC) line voltage 120 (e.g., power supplied from a wall socket) and output a direct current (DC) power supply to drive load 114. In an embodiment, rectifier 102 receives the line voltage 120 directly from a wall socket and converts the AC voltage to a DC voltage. The rectifier 102 may be a full-wave rectifier configured to convert the whole wave signal of the line voltage 120 to a constant polarity (e.g., a positive polarity). Rectifier 102 may be any type of rectifier including a diode bridge rectifier (i.e., a rectifier comprising four diodes in a bridge configuration) and/or a center tapped transformer with two diodes. The output of rectifier 102 is a DC signal that is received by PFC pre-converter 104.

PFC pre-converter 104 is a pre-converter that is configured to receive the DC signal from the rectifier 102 and generate a constant output voltage while providing power factor correction (i.e., drawing a current that is proportional to and in phase with the AC sine-wave line voltage 120). Thus, the PFC pre-converter 104 is configured to remove and/or reduce harmonic content in the power provided to load 114. The PFC pre-converter 104 may include a PFC controller 106 and a boost converter 108. The boost converter 108 is configured to receive the DC voltage generated by the rectifier 102 (i.e., the boost converter input voltage) and step up the voltage to maintain constant DC voltage on its output (i.e., the boost converter output voltage). The PFC controller 106 is configured to control switching within the boost converter 108 such that a constant boost converter output voltage is maintained while providing power factor correction to the boost converter input voltage.

The DC output voltage with power factor correction may be received by energy storing capacitor 110 and provided to power converter 112. The power converter 112 may be configured to convert the DC boost converter output voltage to another DC output voltage to drive load 114 at the desired voltage level.

FIG. 2 shows an illustrative circuit diagram of PFC pre-converter 104 in accordance with various embodiments. The PFC pre-converter 104 may include the PFC controller 106, an inductor 202, a switch 204, and a diode 206. The inductor 202, switch 204, and diode 206 may comprise the boost converter 108. In an embodiment, switch 204 is an enhancement-mode N-channel metal oxide semiconductor field effect transistor (NMOS). In alternative embodiments, switch 204 may be any other type of transistor including a p-channel metal-oxide-semiconductor field-effect (PMOS) transistor, a p-type junction gate field-effect transistor (PJFET), a n-type junction gate field-effect transistor (NJFET), and a bipolar junction transistor (BJT) (including PNP and NPN transistors) that act as switches. When switch 204 is closed (i.e., the on state of the boost converter 108), current flow through the inductor 202 increases. When switch 204 is opened (i.e., the off state of the boost converter 108), current flow through the inductor 202 decreases due to a higher impedance as the current through the inductor flows through the diode 206. In some embodiments, when switch 204 is open, the current through inductor 202 completely discharges to zero prior to the switch 204 closing. The current through inductor 202 may remain at zero for a period of time prior to switch 204 closing so as to provide power factor correction (i.e., operate in a discontinuous mode) while allowing the boost converter to operate in an efficient configuration.

The PFC controller 106 is configured to control the switch 204 by generating signals that open and close the switch 204 in order to provide operating efficiency to the boost converter 108 while also providing power factor correction. As discussed above, the PFC controller 106 may control the switch 204 such that the switch 204 opens and closes in a discontinuous mode (DCM) to provide optimum efficiency for the boost converter 108 while also providing power factor correction. The PFC controller 106 may also control the switching of the switch 204 in a critical conduction mode (CrCM) which operates such that the on state of the boost converter 108 is a fixed period of time. In this mode, once switch 204 opens, current through the inductor 202 discharges until the current through the inductor reaches zero (thus, a variable off time). Once the current through inductor 202 reaches zero, the PFC controller 106 generates a signal that causes switch 204 to close for the fixed on time.

FIG. 3 shows an illustrative circuit diagram of PFC controller 106 in accordance with various embodiments. The PFC controller 106 may include a divider 302, a multiplier 204, pulse extender 306, divider 308, comparator 310, adder 316, multiplier 318, wait logic 320, and gate pulse generator 322. The divider 302 may be configured to divide a constant by the peak of the line voltage 120 squared. In other words, divider 302 may be configured to divide

$$\frac{k}{{V}_{a cpk}^{2}} ,$$

where k is a constant and V_{acpk} is the peak voltage (i.e., largest magnitude) of the AC line voltage 120. The output of divider 302 then may be multiplied by the power demand signal 352 utilizing multiplier 304 to generate a signal indicative of the critical conduction mode on time. In other words, the output of the multiplier 304 provides a signal indicative of the fixed time period that PFC controller 106 controls switch 204 to be closed while operating in the CrCM. In some embodiments, the power demand signal 352 is generated by a voltage feedback circuit that generates an error voltage (i.e., difference between actual output voltage of the boost converter 108 and desired output voltage of the boost converter 108). This error voltage may be filtered for stability to become the power demand signal 352.

Comparator 310 is configured to compare a voltage corresponding with the input current to the PFC controller 106 (i.e., current through inductor 202 which is received by PFC controller 106) (labelled as VISNS(t) 354) with a target value current 356. For example, a current sense resistor in series with the switch 204 or in the return current path between the switch 204 and the input rectifier 102 may detect and provide VISNS(t) 354 to comparator 310. The target value current 356 may be the peak current through the inductor 202 at which boost converter 108 operates most efficiently and, in some embodiments, may be predetermined and preprogrammed into PFC controller 104. Thus, comparator 310 determines whether the current through inductor 202 has reached the peak current for efficient operation of boost converter 108 (i.e., the target value current 356) or if the current through the inductor 202 is less than the peak current for efficient operation of boost converter 108. In some embodiments, the comparator 310 is configured to output a HIGH comparator 310 output signal in response to the input current (i.e., current through inductor 202) reaching (i.e., equaling) the target value current 356 and a LOW comparator 310 output signal in response to the input current (i.e., current through inductor 202) being less than the target current value.

The pulse extender 306 is electrical logic configured to compare the comparator 310 output signal to the critical conduction mode on time and output a signal indicative of the adjusted on time based on the comparison. More particularly, the pulse extender 306 is configured to generate a signal indicates that the adjusted on time is equal to the critical conduction mode on time in response to a determination that the comparator output signal from comparator 310 is HIGH (i.e., the input current equals the target value current 356) prior to the end of the critical conduction mode on time. In other words, if the critical conduction mode on time has not expired (i.e., the fixed time calculated by multiplier 304 from the closing of switch 204) prior to the current through inductor 202 reaching the target current value 356, the pulse extender generates an adjusted on time that is equal to the critical conduction mode on time. However, if the comparator 310 output signal from comparator 310 is LOW (i.e., the input current is less than the target value current 356) at the time critical conduction mode on time ends, the pulse extender 306 generates a signal indicating that the adjusted on time is greater than the critical conduction mode on time. More particularly, the pulse extender 306 may determine that the adjusted on time ends at the time that the input current equals the target value current 356. Thus, if the critical conduction mode on time has ended, once the comparator 310 generates a HIGH comparator output signal, the pulse extender 306 may generate the adjusted on time signal indicating a time period that is equivalent to the time that the switch 204 closes to the time that the input current (i.e., current through inductor 202) equals the target current value 356.

The gate pulse generator 362 is configured to generate a gate drive signal 362 to drive the gate of switch 204 causing the switch 204 to open and close. Once the adjusted on time has ended (i.e., the time from switch 204 closing to the end of the adjusted on time), gate pulse generator 322 receives a signal indicative that the adjusted on time has ended from pulse extender 306 and generates a gate drive signal 362 that causes the switch 204 to open, thus discharging current through inductor 202. In some embodiments, the pulse extender 306 generates a HIGH or LOW signal once the adjusted on time ends causing the gate pulse generator to generate an equivalent HIGH or LOW signal to drive the gate of switch 204, closing switch 204. In this manner, the PFC controller 106 is able to create efficiency in boost converter 108 due to more efficient switching as compared to a conventional PFC controller.

In order to maintain power factor correction, divider 308 may be configured to receive the signal indicative of the critical conduction mode on time generated by multiplier 304 and the signal indicative of the adjusted on time generated by pulse extender 306. Divider 308 is configured to divide the adjusted on time by the critical conduction mode on time to generate a discontinuous mode ratio. Adder 316 is configured to receive the signal indicative of the adjusted on time generated by pulse extender 306 and a discharge time signal 358 from the boost converter 108. The discharge time signal 358 is a signal indicative of the time that it takes to discharge inductor 202 to zero after switch 204 opens (i.e., the discharge time). For example, an auxiliary winding on the inductor 202 may detect when the current through the inductor 202 reaches zero. Once the current through inductor 202 reaches zero, the diode 206 ceases conduction; therefore, the voltage across the inductor 202 changes. The current through inductor 202 reaching zero is detected by the auxiliary winding by detecting this change in voltage across the inductor 202. Once the current through the inductor 202 discharges to zero, a signal indicative of the time period from switch 204 opening to current through inductor 202 reaching zero is provided to the adder 316 as discharge time signal 358. Adder 316 is configured to add the adjusted on time to the discharge time to generate a signal indicative of the power stage time (i.e., the time period that current flows through inductor 202).

Multiplier 318 is configured to receive the signal indicative of the power stage time generated by adder 316 and the discontinuous mode ratio generated by divider 308. Multiplier 318 is configured to multiply the power stage time with the discontinuous mode ratio to generate a signal representative of the total period of time for switching closed switch 204. The total period of time for switching closed switch 204 is the amount of time from gate pulse generator 322 generating a signal causing switch 204 to close to the gate pulse generator 322 generating a signal causing switch 204 to close a second time (during the total time period, the gate pulse generator 322 also generates a signal causing the switch 204 to open as discussed above).

Wait for valley circuitry 320 may receive the signal indicative of the total period of time for switching closed switch 204 and/or the signal indicative of the total period of time for switching closed switch 204 may be provided directly to gate pulse generator 322. Wait for valley 320 circuitry may also receive a valley detection signal 360. The valley detection signal 360 is a signal from the boost converter 108 that indicates that the switch 204 voltage (on the drain of switch 204) has resonated to a minimum value. In some embodiments, the wait for valley circuitry 320 compares the valley detection signal 360 with the signal indicative of total period of time for switching closed switch 204. If the valley detection signal 360 indicates that the switch 204 voltage has resonated to a minimum value prior to receiving a signal indicating that the total period of time has ended, then the wait for valley circuitry 320 generates a generate gate pulse signal to the gate pulse generator once the wait for valley circuitry 320 receives the signal indicating that the total period of time has ended. However, if the valley detection signal 360 indicates that the switch 204 voltage has not resonated to a minimum value prior to receiving a signal indicating that the total period of time has ended, then the wait for valley circuitry 320 generates a generate gate pulse signal to the gate pulse generator once the valley detection signal 360 indicates that the switch 204 voltage has resonated to a minimum value.

In an embodiment, once the gate pulse generator 322 receives the generate gate pulse signal from the wait for valley circuitry 320, the gate pulse generator 322 generates gate drive signal 362 to close switch 204. In another embodiment, the gate pulse generator 322 may directly receive the signal indicating that the total period of time has ended from the multiplier 318 and generate the gate drive signal 362 to close switch 204 once the signal indicating that the total period of time has ended is received. In this way, the PFC controller 106 is able to control switching of switch 204 by generating a signal to open switch 204 for optimal efficiency of boost converter 108 while also generating a signal to close switch 204 to maintain power factor correction.

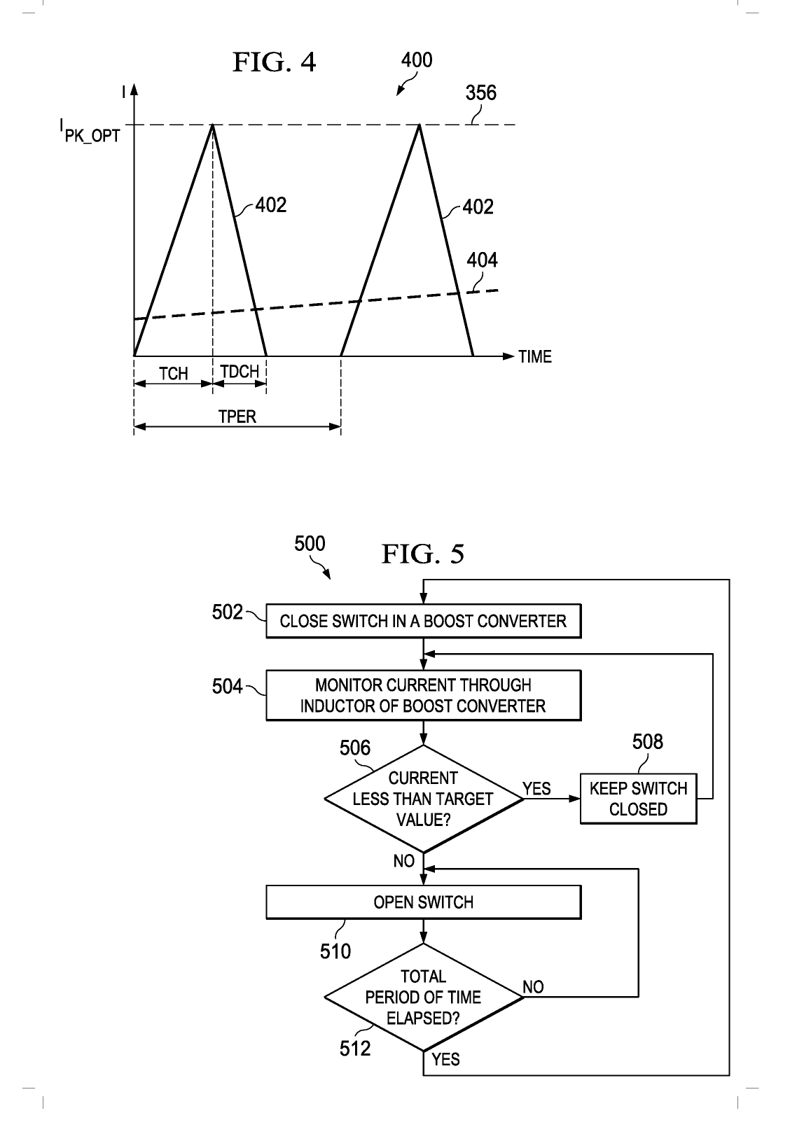

FIG. 4 shows an illustrative timing diagram 400 of current 402 through inductor 202 of a boost converter 108 of a PFC pre-converter 104 in accordance with various embodiments. At time 0, switch 204 closes. At this point, current through inductor 202 increases in a linear manner until the current 402 reaches the target current value 356 (i.e., equals the target current value 356). The time period for the current 402 to increase from 0 to the target current value 356 is the adjusted on time. As discussed above, once the adjusted on time ends, the pulse extender 306 generates a signal indicating that the adjusted on time has ended. The gate pulse generator 322 then generates gate drive signal 362 causing the switch 204 to open. Once the switch 204 opens, the current 402 through the inductor 202 discharges in a linear manner until the current 402 reaches 0. The time period for the current 402 to discharge from the target current value 356 to 0 is the discharge time. Once the total period of time ends, which as discussed above is calculated by the multiplier 318, the adder 316, and the divider 308 according to the equation

$${T}_{PER} = \frac{{T}_{CH}}{{T}_{CHCrM}} \times ( {T}_{CH} + {T}_{DCH} ) ,$$

where T_{PER} represents the total period of time, T_{CH} represents the first period of time, T_{CHCrM} represents the critical conduction mode on time, and T_{DCH} represents the discharge period of time, the gate pulse generator 322 may generate a gate drive signal 362 that causes switch 204 to close and the current 402 through inductor 202 increases linearly to the target current value 356. This process may continually repeat to generate the boost converter output voltage. Because the adjusted on time may be longer than the on time of a conventional CrCM PFC controller, the boost converter 108 is more efficient due to the lower switching frequency. Additionally, due to the increased total period of time for switching, the cycle average 404 of the current 402 through the inductor 202 is maintained as compared to the conventional CrCM PFC controller. Thus, power factor correction is also maintained. Therefore, the PFC controller 106 allows for greater efficiency in the boost converter 108 while also providing power factor correction.

FIG. 5 shows an illustrative flow diagram of a method 500 for optimizing load efficiency of a PFC pre-converter in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 500, as well as other operations described herein, can be performed by PFC controller 106, including the dividers 302 and 308, the multipliers 304 and 318, adder 316, comparator 310, pulse extender 306, wait for valley circuitry 320, and/or gate pulse generator 322, and/or boost converter 108, including inductor 202, switch 204, and/or diode 206, and implemented in logic and/or by a processor executing instructions stored in a non-transitory computer readable storage medium.

The method 500 begins in block 502 with closing a switch in a boost converter of a PFC pre-converter for a predetermined critical conduction mode on time. For example, gate pulse generator 322 may generate a gate drive signal 362 that causes switch 204 to close. Closing switch 204 causes current 402 through inductor 202 to increase from zero. The switch is configured to be closed for at least the critical conduction mode on time which may be generated by multiplier 304 by multiplying the power demand signal 352 with the output of divider 302 which is a ratio of a constant to the peak of line voltage 120 squared.

In block 504, the method 500 continues with monitoring the current through the inductor. For example, a current sense resistor in series with the switch 204 or in the return current path between the switch 204 and the input rectifier 102 may detect and provide signals that indicate the current 402 that is flowing through inductor 202. The method 500 continues in block 506 with determining whether the current through the inductor is less than a target current value at the end of the critical conduction mode on time. For example, pulse extender 306 may compare the critical conduction mode on time with the target current value 356 and/or a signal that indicates that the current 402 through inductor 202 is equal to the target current value 356.

If, in block 506, a determination is made that the current through the inductor is less than a target current value, the method 500 continues in block 508 with keeping the switch closed. For example, if the pulse extender 306 determines that the current 402 through inductor 202 is less than the target current value, then the pulse extender 306 will not generate a signal indicating that the adjusted on time has ended. Therefore, the gate pulse generator 322 will not generate a gate drive signal 362 to open the switch 204. Thus, the switch 204 will remain closed. The method 500 continues in block 504 with continuing to monitor the current through the inductor of the boost converter.

If, however, in block 506 a determination is made that the current through the inductor is not less than a target current value, the method 500 continues in block 510 with opening the switch. For example, if the pulse extender 306 determines that the current 402 through inductor 202 is equal to the target current value, then the pulse extender 306 will generate a signal indicating that the adjusted on time has ended. Therefore, the gate pulse generator 322 will generate a gate drive signal 362 to open the switch 204.

In block 512, the method 500 continues with determining whether a total period of time for switching the switch has elapsed. For example, the total period of time may be determined by the multiplier 318, the adder 316, and the divider 308 according to the equation

$${T}_{PER} = \frac{{T}_{CH}}{{T}_{CHCrM}} \times ( {T}_{CH} + {T}_{DCH} ) ,$$

where T_{PER} represents the total period of time, T_{CH} represents the first period of time, T_{CHCrM} represents the critical conduction mode on time, and T_{DCH} represents the discharge period of time. The multiplier 318 may generate a signal indicative of whether the total period of time has elapsed.

If, in block 512, a determination is made that the total period of time for switching the switch has not elapsed, the method 500 continues in block 510 with keeping the switch open. However, if, in block 512, a determination is made that the total period of time for switching the switch has elapsed, the method 500 continues in block 502 with closing the switch. For example, once the multiplier 318 generates a signal that indicates that the total period of time for switching has ended, the gate pulse generator 322 may generate a gate drive signal 362 that causes the switch 204 to close.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A power factor correction (PFC) controller, comprising:
a comparator configured to compare an input current with a target current value and output a comparator output signal based on the comparison;
a first multiplier configured to generate a critical conduction mode on time based on a ratio of power demand for a boost converter in a PFC pre-converter to a peak line voltage;
a pulse extender configured to compare the comparator output signal to the critical conduction mode on time and output an adjusted on time based on the comparison;
a divider configured to divide the adjusted on time by the critical conduction mode on time to generate a discontinuous mode ratio;
an adder configured to add the adjusted on time to a discharge time to generate a power stage time;
a second multiplier configured to multiply the discontinuous mode ratio with the power stage time to generate a total period of time; and
a gate pulse generator configured to, in response to the total period of time ending, generate a gate drive signal to close a switch in the boost converter.

2. The PFC controller of claim 1, wherein the comparator is further configured to output a HIGH comparator output signal in response to the input current equaling the target current value and a LOW comparator output signal in response to the input current being less than the target current value.

3. The PFC controller of claim 2, wherein the pulse extender is further configured to generate an adjusted on time that is equal to the critical conduction mode on time in response to a determination that the comparator output signal is HIGH prior to an end of the critical conduction mode on time.

4. The PFC controller of claim 2, wherein the pulse extender is further configured to generate an adjusted on time that is greater than the critical conduction mode on time in response to a determination that the comparator output signal is LOW at an end of the critical conduction mode on time.

5. The PFC controller of claim 1, wherein the gate pulse generator is further configured to, in response to an end of the adjusted on time, generate a gate drive signal to open the switch in the boost converter.

6. The PFC controller of claim 5, wherein the discharge time is determined by monitoring an inductor in the boost converter after the switch opens and determining when current through the inductor equals zero.

7. The PFC controller of claim 1, wherein the power demand is determined is determined by measuring voltage on an output of the boost converter.

8. A power factor correction (PFC) pre-converter, comprising:
a boost converter configured to step up a boost converter input voltage by generating a boost converter output voltage, the boost converter including an inductor, a switch, and a diode; and
a PFC controller configured to control the switch by:
generating a signal causing the switch to be closed for a first period of time, the first period of time ending when current through the inductor reaches a target current value; and
in response to the first period of time ending, generating a signal causing the switch to be open for a second period of time, the second period of time being based on a ratio between the first period of time and a critical conduction mode on time, wherein the PFC controller is further configured to adjust a total period of time equal to the first period of time plus the second period of time according to the equation
$${T}_{PER} = \frac{{T}_{CH}}{{T}_{CHCrM}} \times ( {T}_{CH} + {T}_{DCH} ) ,$$
wherein T_{PER} represents the total period of time, T_{CH} represents the first period of time, R_{CHCrM} represents the critical conduction mode on time, and T_{DCH} represents the discharge period of time.

9. The PFC pre-converter of claim 8, wherein the PFC controller is further configured to control the switch by, in response to the second period of time ending, generating a signal causing the switch to be closed for a third period of time ending when current through the inductor reaches the target current value.

10. The PFC pre-converter of claim 9, wherein the first period of time is equal to the third period of time.

11. The PFC pre-converter of claim 8, wherein the current through the inductor linearly increases from zero to the target current value during the first period of time.

12. The PFC pre-converter of claim 11, wherein the current through the inductor linearly decreases from the threshold value to zero during a discharge period of time, the discharge period of time being a first subset of the second period of time.

13. The PFC pre-converter of claim 12, wherein the current through the inductor is at zero during a third period of time, the third period of time being a second subset of the second period of time.

14. (canceled)

15. The PFC pre-converter of claim 8, wherein the switch is an enhancement-mode N-channel metal oxide semiconductor field effect transistor (NMOS).

16. A method of optimizing load efficiency of a power factor correction (PFC) pre-converter, comprising:
closing a switch in a boost converter of the PFC pre-converter a first time causing current to increase through an inductor of the boost converter from zero for a predetermined critical conduction mode on time;
monitoring current through the inductor;
in response to current through the inductor being at a target current value at an end of the critical conduction mode on time, opening the switch causing current through the inductor to decrease to zero;
in response to the current through the inductor being less than the target current value at the end of the critical conduction mode on time, keeping the switch closed past the end of the critical conduction mode on time for an adjusted on time which ends when the current through the inductor is at the target current value;
in response to the current through the inductor being at the target current value at the end of the adjusted on time, opening the switch causing current through the inductor to decrease to zero; and
closing the switch a second time at an end of a total period of time, the total period of time being based on a ratio between the adjusted on time and the critical conduction mode on time, wherein the total period of time is set according to the equation
$${T}_{PER} = \frac{{T}_{CH}}{{T}_{CHCrM}} \times ( {T}_{CH} + {T}_{DCH} ) ,$$
wherein T_{PER} represents the total period of time, T_{CH} represents the adjusted on time, T_{CHCrM} represents the critical conduction mode on time, and T_{DCH} represents a discharge time, the discharge time being an amount of time to discharge current through the inductor to zero once the switch is opened.

17. The method of claim 16, wherein the total period of time begins when the switch is closed the first time.

18. (canceled)

19. The method of claim 16, wherein a current sense resistor in series with the switch monitors the current through the inductor.

20. The method of claim 16, wherein the switch is an enhancement-mode N-channel metal oxide semiconductor field effect transistor (NMOS).
